(19) United States
(12) Patent Application Publication
(10) Pub. No.: US 2013/0134947 A1
(43) Pub. Date: May 30, 2013

(54) POWER CONSUMPTION CONTROL METHOD FOR AN ELECTRONIC SYSTEM AND ELECTRONIC SYSTEM THEREOF

(71) Applicant: Bing-Hung Wang, New Taipei City (TW)

(72) Inventor: Bing-Hung Wang, New Taipei City (TW)

(21) Appl. No.: 13/551,621

(22) Filed: Jul. 18, 2012

(30) Foreign Application Priority Data
Nov. 30, 2011 (TW) 100143986

(51) Int. Cl. H02J 4/00; H02J 7/00

(52) U.S. Cl. 320/137; 307/35

(57) ABSTRACT

Power consumption control method for an electronic system determines whether an external device is plugged in one of the connection ports of the electronic system by detecting the variation of average power consumption of the electronic system. The one connection port with plugged external device is then turned on and provided with power, making the external device workable. The external device may further be charged after confirmation of connection to the connection port. Completion of charging and status of unplugging of the external device may further be acquired in the electronic system by also detecting the variation of average power consumption, which will subsequently turn off the charger circuit and the connection port for substantially saving power consumption and prolonging the battery time.

### BACKGROUND OF THE INVENTION

1. Field of the Invention

The invention relates to a power consumption control method for an electronic system and the electronic system thereof, and more particularly, to a power consumption control method that selectively turns off the power supply for unused connection ports via detecting the variation of average power consumption and related electronic system.

2. Description of the Prior Art

It is very common for an electronic system to equip with connection ports adapted to receive many external devices to enhance the expandability of the system. Connection ports like the USB ports are the popular ones for various kinds of external devices. As an external device is plugged to the connection port of the electronic system, necessary verification procedure is carried out before the external device is identified by the electronic system, as a pen drive, an external hard drive, an optical drive, a multimedia device, etc. Once identified as a specific device, the electronic system then provides necessary functional and power connections for the external device.

To perform a specific function toward some external devices, such as an USB charging circuit of the electronic system to charge a built-in rechargeable battery of the external device, the charging circuit must check first whether one of the connection ports is connected with the specific external device. To properly recognize an external device connection to a connection port, initiate corresponding specific function (such as charging the external device by the charging circuit), and stop the corresponding function when the external device is removed from the connection port, some detection mechanism should be used in the electronic system to accurately recognize a plug-in of an external device to any one connection port. For those connection ports with common standards, which have regulation of how and what each connection pin should be deployed and used, the detection mechanism usually requires modification of the hardware wiring toward the connection pins or addition of extra wiring to the connection ports. However, cost and complexity for the design certainly rise when changing the hardware wiring.

### SUMMARY OF THE INVENTION

In order not to add cost and complexity to the hardware design of an electronic system, an embodiment of the invention provides a power consumption control method for an electronic system. The electronic system includes a plurality of connection ports adapted to be plugged with one or more external devices. The power consumption control method includes using a control unit of the electronic system to execute the following steps: obtaining an average power consumption of the electronic system; checking a power consumption of each of the plurality of the connection ports when a variation of the average power consumption of the electronic system exceeding a predetermined value is detected; providing power for one of the plurality of connection ports when the connection port is detected to have an increase of the power consumption exceeding the predetermined value; and turning off the connection port when the connection port is detected to have a decrease of the power consumption exceeding the predetermined value.

Given the aforementioned method, an electronic system is also provided by the embodiment of the invention. The electronic system includes a plurality of connection ports, a power supply unit, and a control unit. The plurality of connection ports is adapted to be plugged with one or more external devices. The power supply unit is electrically connected to the plurality of connection ports respectively and is utilized for providing power for the plurality of connection ports. The control unit is electrically connected to the power supply unit and the plurality of connection ports and is utilized for obtaining an average power consumption of the electronic system from the power supply unit, checking a power consumption of each of the plurality of the connection ports when a variation of the average power consumption of the electronic system exceeding a predetermined value is detected, providing power for one of the plurality of connection ports when the connection port is detected to have an increase of the power consumption exceeding the predetermined value, and turning off the connection port when the connection port is detected to have a decrease of the power consumption exceeding the predetermined value.

With the embodiments provided in the invention, no additional detecting wiring is needed for the connection ports, yet being capable of detecting whether an external device is plugged with any one connection port by checking the variation of the average power consumption of the system, in the software or firmware level. Substantial reduction of power consumption to the system under a power saving mode is attainable, which extends the battery time.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an illustration showing an electronic system connected with an external device according to an embodiment of the invention.

FIG. 2 is an illustration showing a flow chart of a power consumption control method of the electronic system according to the invention.

FIG. 3 is an illustration showing a flow chart of an external device charging method of the power consumption control method 100 according to the invention.

### DETAILED DESCRIPTION

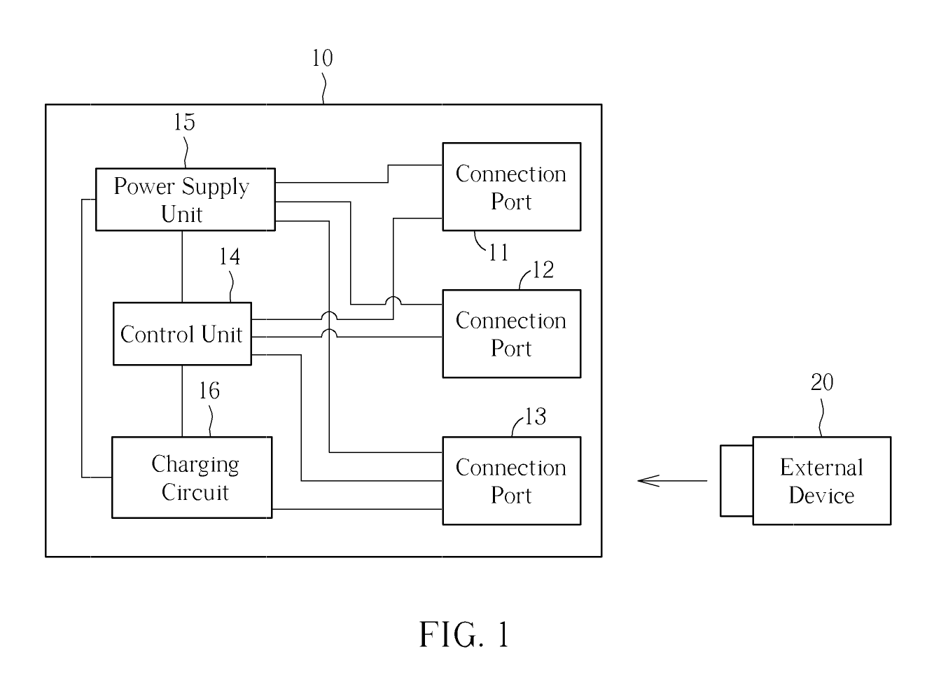

Please refer to FIG. 1. FIG. 1 is an illustration of the present invention showing an electronic system 10 connected with an external device 20. The electronic system 10 may be a personal computer (PC), a laptop computer, a server, a mobile device, a multimedia device, etc., which has a number of connection ports 11, 12, 13 adapted to be plugged with one or more external devices 20 such that the electronic system 10 may have expansion functions through the external devices 20. The connection ports 11, 12, 13 may be of an universal serial bus (USB) standard, an IEEE 1394 standard, an external serial advanced technology attachment (eSATA) standard, etc. each having same or different standard with one another. The external device 20 may be a pen drive, an external hard drive, an optical drive, a multimedia device, etc. Some external devices 20 are portable mobile devices that are built in with rechargeable battery module, which is not shown in the figure, to provide power for the external device 20 absent of connection to the electronic system 10. These external devices 20 having rechargeable battery module may have the battery module charged by the electronic system 10 when the external devices 20 are plugged with the electronic system 20.

The electronic system 10 further includes a power supply unit 15 electrically connected to the connection ports 11, 12, 13 respectively and can provide necessary power for the connection ports 11, 12, 13, either for simply connection or further for charging the battery. As one of the connection ports 11, 12, 13 is turned on, connected with an external device 20, and/or the external device 20 charges its battery through one connection port, provision of power by the power supply unit 15 causes continuously variation of system's power consumption. In particular, the power supply unit 15 may be a rechargeable battery module of the electronic system 10 or a power supply unit (PSU) connected to an AC power source.

The electronic system 10 further includes a control unit 14 and a charging circuit 16. The control unit 14 is electrically connected to the power supply unit 15 and the plurality of connection ports 11, 12, 13 respectively. The charging circuit 16 is electrically connected to the power supply unit 15, the control unit 14, and one or more connection ports 11, 12, 13. The embodiment in FIG. 1 shows that the charging circuit 16 is electrically connected to the connection port 13, which however, should no be regarded as a limitation. The charging circuit 16 may also be electrically connected to any one or all the connection ports 11, 12, 13. The control unit 14 may be a south bridge or a central processing unit of the personal computer, or an embedded controller (EC) of a laptop computer or a portable device. In the embodiments of the invention, the control unit 14 may be utilized for obtaining an average power consumption of the electronic system 10 or individual power consumption of each component within the electronic system 10. The control unit 14 is also utilized for turning on or turning off the connection ports 11, 12, 13.

The embodiments of the invention provides that when the control unit 14 is configured at a workable state, the control unit 14 performs efficient control over the power consumption of the electronic system 10, in that the power consumed by unnecessary components or connection ports of the electronic system 10 is reduced and the battery time of the electronic system 10 is extended as the rechargeable battery module is used as the only power source of the electronic system 10.

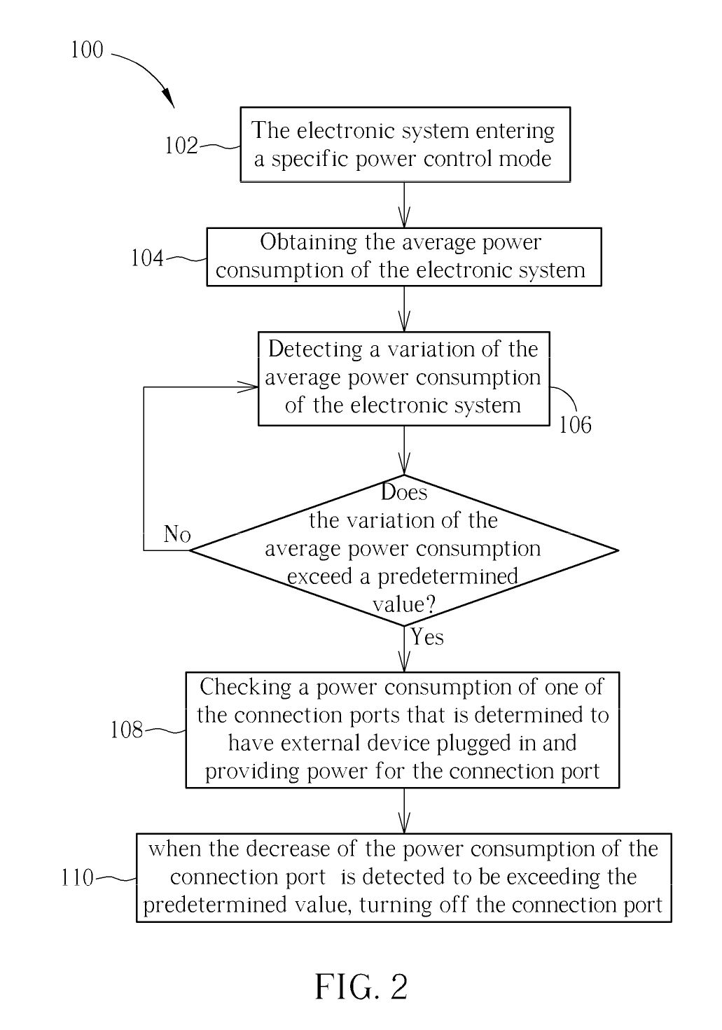

Please refer to FIG. 2. FIG. 2 is an illustration showing a flow chart of a power consumption control method 100 of the electronic system 10 according to the invention. The steps of the method are as followed:

Step 102: the electronic system 10 entering a specific power control mode, which sets the electronic system 10 with steady average power consumption and the control unit 14 is configured at a workable state under the specific power control mode;

Step 104: the control unit 14 obtaining the average power consumption of the electronic system 10;

Step 106: detecting a variation of the average power consumption of the electronic system 10 and checking whether the variation of the average power consumption exceeds a predetermined value;

Step 108: when the variation of the average power consumption of the electronic system is detected to be exceeding the predetermined value, checking a power consumption of each of the connection ports 11, 12, 13; providing power for the connection port 13 since it is the connection port 13 that is detected to have variation (increase, to be more exactly) of the power consumption exceeding the predetermined value and the connection port 13 is determined to have external device 20 plugged in;

Step 110: when the variation (decrease, to be more exactly) of the power consumption of the connection port 13 is detected to be exceeding the predetermined value, removal of the external device 20 plugged with the connection port 13 is determined and the connection port 13 is turned off.

Generally, reducing the power consumption of the electronic system 10 is taken into consideration when the electronic system 10 is under a power saving mode and has a need of extending the battery time by means of some technique. Hence, Step 102 describes that the electronic system 10 is going to have steady power consumption when configured at a specific power control mode, which complies with, for example, the sleep/S3 mode, the hibernate/S4 mode, or the power off/S5 mode regulated by the Advanced Configuration and Power Interface (ACPI) standard. Under such power control modes of some specific standard, the electronic system 10 has most of its inner components turned off but allows few components to be powered according to different modes. For example, in the sleep/S3 mode of the ACPI standard, all the temporary data needed for operation of the system is kept in the random access memory (RAM), which means the RAM, the control unit 14, and the connection ports 11, 12, 13 are powered by the system, while the rest components are turned off. In the hibernate/S4 mode, the temporary data will be moved from the RAM to the hard disk drive (HDD). Since the HDD need no electricity to keep the data and all the temporary data has been moved out of the RAM, the RAM may further be turned off under the hibernate/S4 mode, while the control unit 14 and some particular components such as a connection port adapted to receive some external devices are still provided with power. In the power off/S5 mode, only the control unit 14 is powered, with all the other components turned off.

These power control modes keep the electronic system 10 in a steady power consumed state, which means the power supply unit 15 will have steady power output. Besides these common ACPI power control modes, the method of the invention may also be applicable under other unlisted power control modes. To put it further, in Step 102, the electronic system 10 may not be necessarily needed to be configured under some specific power control mode to perform the method of the invention. In other words, the method of the invention may be applied on the electronic system 10 as long as the electronic system 10 has steady average power consumption and the control unit 14 is under a workable state, even when the electronic system 10 is set under a normal mode.

Whether any specific power control mode aforementioned or the normal mode, it is possible for one or more connection ports 11, 12, 13 to be configured at a turned on state due to the regulation of some power control mode or a special requirement, such that the turned-on connection port(s) can make the connecting external device 20 work properly. As for those connection ports not in connections with any external device 20, they can be turned off for saving the consumed power of the system.

Given the condition that the electronic system 10 has steady average power consumption in Step 102, the control unit 14 then obtains the average power consumption of the electronic system 10 from the power supply unit 15 in Step 104 and detects the variation of the average power consumption of the electronic system 10 to check if connection or removal of an external device 20 exists. Practically, the control unit 14 checks whether the variation of the average power consumption exceeds the predetermined value. For example, when an external device 20 is plugged with the connection port 13, a certain power is consumed by the external device 20 in the connection port 13 even the electronic system 10 has not established any data transmission or charging connection to the external device 20. Hence, the predetermined value described in Step 106 may be set to be the lowest power consumption required when the external device 20 is plugged with the connection port 13.

As for an exemplary embodiment, one connection port will still consume 1 mW from the system even when the connection port is turned on but absent of connection to any external device. Once an external device 20 is plugged with any one connection port, the connection port will consume at least 11 mW from the system. In this case, if the predetermined value in Step 106 is set to be 9 mW, connection of the external device 20 to the connection port makes the control unit 14 recognize the variation of average power consumption of the electronic system 10 exceeding the predetermined value, representing that an external device 20 is plugged with the electronic system 10.

In Step 108, the control unit 14 has detected that it is the connection port 13 that has variation of the power consumption exceeding the predetermined value and the variation is an increase variation. Practically, the control unit 14 may check the power consumption of each of the connection ports 11, 12, 13 by polling through the connection ports and easily find out it is the connection port 13 that causes the increase of the average power consumption of the electronic system 10. So, the control unit 14 recognizes that an external device 20 is plugged with the connection port 13 and the control unit 14 turns on the connection port 13, providing power for the connection port 13. To be more exactly, the connection port 13 is having a “turned on and provided with power” state as the control unit 14 is polling through the connection port 13. Confirmation by the control unit 14 that the connection port 13 is plugged with an external device 20 maintains the connection port 13 at its powered state, while other connection ports 11, 12 absent of connection of external device may go through short period of turned on for polling check only but will not be provided with powered afterward. Hence, the connection ports 11, 12 can be regarded as being maintained at a turned off state. In such way, to turn off the unused components or the connection ports (and the charging circuit for providing a charging current to these connection ports) may effectively save the overall average power consumption of the electronic system 10, extending the battery time of the rechargeable battery module of the electronic system 10.

When the connection port 13 of the electronic system 10 is plugged with the external device 20, removal of the external device 20 from the connection port 13 will lead to the decrease of power consumption of the connection port 13, which equivalently to the variation (a decrease variation) of average power consumption of the electronic system 10 exceeding the predetermined value. The control unit 14 may confirm that the external device 20 has been removed by detecting the variation of average power consumption of the electronic system 10. The connection port 13 is then turned off by the control unit 14 for saving the overall average power consumption of the electronic system 10 and extending the battery time.

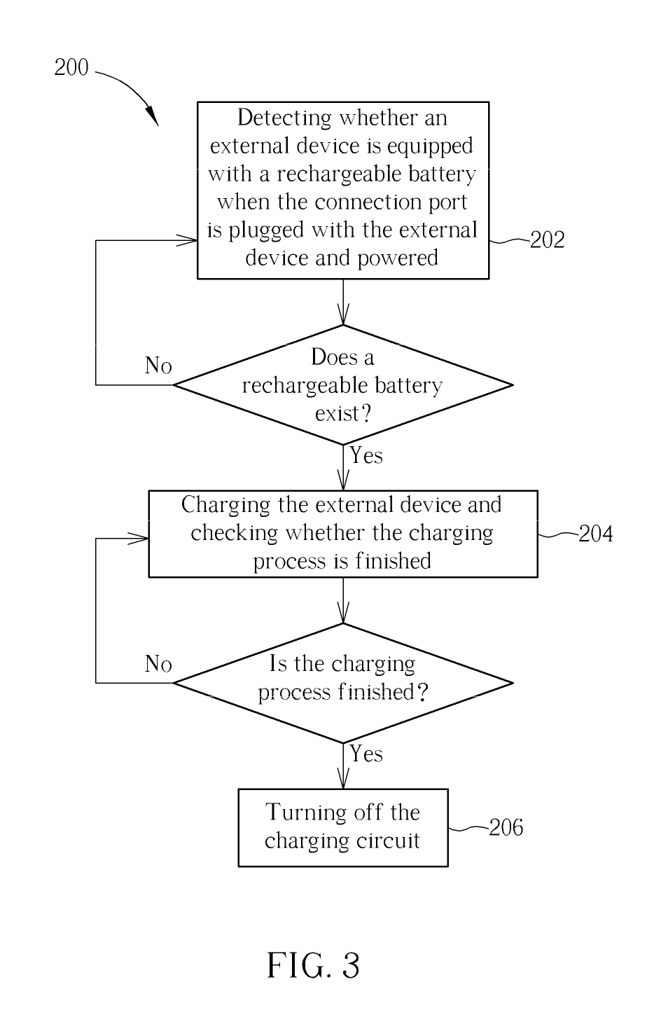

Please refer to FIG. 3. FIG. 3 is an illustration showing a flow chart of an external device charging method 200 of the power consumption control method 100 according to the invention. After the connection port 13 connected with the external device 20 is turned on as in Step 108, a specific operation may further be performed on the external device 20 in the invention. For example, for the external device 20 as a portable device having built-in rechargeable battery, the charging circuit 16 may be activated to charge the external device 20, which has steps as followed:

Step 202: detecting whether an external device 20 is equipped with a rechargeable battery when the connection port 13 is plugged with the external device 20 and powered;

Step 204: the charging circuit 16 charging the external device 20 and checking whether the charging process is finished by referring to the variation of average power consumption of the electronic system 10;

Step 206: turning off the charging circuit 16.

As described in Step 202, charging the rechargeable battery of the external device 20 should be carried out under the condition that Step 108 of the power consumption control method 100 sustains. A practical way of detecting whether the external device 20 is equipped with a rechargeable battery may be using the control unit 14 to control the charging circuit 16 to provide a charging voltage to the external device 20 and meanwhile the control unit 14 checks the average power consumption of the electronic system 10. The variation of average power consumption of the electronic system 10 provides useful information for detecting a rechargeable battery of the external device 20. Having a rechargeable battery in the external device 20, Step 204 is then performed by the control unit 14 controlling the charging circuit 16 to keep providing the charging voltage to the external device 20 that will subsequently charge the external device 20 connected to the connection port 13. Variation of the increase of average power consumption of the electronic system 10 is also used to determine if the charging process is finished.

For example, when the external device 20 is connected to the connection port 13 (as in Steps 106, 108), the increase of the average power consumption of the electronic system 10 changes from 1 mW to 11 mW, which exceeds the predetermined value as exemplified as 9 mW in the previous paragraph. As the charging circuit 16 provides the charging voltage to further charge the external device 20, the increase of the average power consumption of the electronic system 10 further changes to 100 mW, which means the increase variation of the average power consumption increases from exceeding the predetermined value to being greater than a charging power consumption, 50 mW for example. Such result shows that the external device 20 is recognized to have a rechargeable battery and will remain being charged. Once the charging process of the external device 20 is finished and the electronic system 10 no longer charges the rechargeable battery of the external device 20, the power consumption by the external device 20 will decrease accordingly such that the decrease of the average power consumption of the electronic system 10 exceeds the charging power consumption, i.e., the variation of the average power consumption changes from 100 mW to 11 mW. In this stage, the control unit 14 determines that the charging process of the external device 20 is finished and turns off the charging circuit 16 in Step 206 for saving power of the electronic system 10.

Please be noted that the external device charging method 200 is not always necessary to carry out the method provided in the invention, i.e., the power consumption control method 100 emphasizes on detecting the variation of the average power consumption of the electronic system 10 to check whether or not an external device is connected to a connection port and which connection port, without the need of amending the hardware wiring of each connection port. The very connection port with a detected external device is then powered for full function of the external device. Charging the external device or using other component of the electronic system 10 toward the external device is optional during the method.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power consumption control method for an electronic system, the electronic system comprising a plurality of connection ports adapted to be plugged with one or more external devices, the power consumption control method comprising using a control unit of the electronic system to execute the following steps:
obtaining an average power consumption of the electronic system;
checking a power consumption of each of the plurality of the connection ports when a variation of the average power consumption of the electronic system exceeding a predetermined value is detected;
providing power for one of the plurality of connection ports when the connection port is detected to have an increase of the power consumption exceeding the predetermined value; and
turning off the connection port when the connection port is detected to have a decrease of the power consumption exceeding the predetermined value.

2. The power consumption control method of claim 1, wherein obtaining an average power consumption of the electronic system comprising the following step: the control unit obtaining the average power consumption of the electronic system when the electronic system is configured at a specific power control mode and has steady average power consumption.

3. The power consumption control method of claim 2, wherein the specific power control mode complies with the sleep/S3 mode, the hibernate/S4 mode, or the power off/S5 mode regulated by the Advanced Configuration and Power Interface (ACM) standard, and the control unit is configured at a workable state under the specific power control mode.

4. The power consumption control method of claim 1, wherein the control unit obtains the average power consumption of the electronic system from a power supply unit of the electronic system.

5. The power consumption control method of claim 1, wherein the control unit checks the power consumption of each of the plurality of the connection ports by polling.

6. The power consumption control method of claim 1, wherein the predetermined value is a lowest power consumption required for an external device to normally function when plugged with the connection port.

7. The power consumption control method of claim 1, further comprising step:
activating a charging circuit to charge an external device connected to the connection port when providing power for the connection port, wherein an increase of the average power consumption of the electronic system increases from exceeding the predetermined value to being greater than a charging power consumption.

8. The power consumption control method of claim 7, further comprising step:
the charging circuit stops charging the external device connected to the connection port and the charging circuit is turned off when a decrease of the average power consumption of the electronic system is larger than the charging power consumption.

9. An electronic system, comprising:
a plurality of connection ports adapted to be plugged with one or more external devices;
a power supply unit, electrically connected to the plurality of connection ports respectively and utilized for providing power for the plurality of connection ports; and
a control unit, electrically connected to the power supply unit and the plurality of connection ports and utilized for obtaining an average power consumption of the electronic system from the power supply unit, checking a power consumption of each of the plurality of the connection ports when a variation of the average power consumption of the electronic system exceeding a predetermined value is detected, providing power for one of the plurality of connection ports when the connection port is detected to have an increase of the power consumption exceeding the predetermined value, and turning off the connection port when the connection port is detected to have a decrease of the power consumption exceeding the predetermined value.

10. The electronic system of claim 9, wherein the control unit is utilized for obtaining the average power consumption of the electronic system when the electronic system is configured at a specific power control mode and has steady average power consumption.

11. The electronic system of claim 10, wherein the specific power control mode complies with the sleep/S3 mode, the hibernate/S4 mode, or the power off/S5 mode regulated by the Advanced Configuration and Power Interface (ACPI) standard, and the control unit is configured at a workable state under the specific power control mode.

12. The electronic system of claim 9, wherein the control unit is utilized for checking the power consumption of each of the plurality of the connection ports by polling.

13. The electronic system of claim 9, wherein the predetermined value is a lowest power consumption required for an external device to normally function when plugged with the connection port.

14. The electronic system of claim 9, further comprising a charging circuit, electrically connected to the power supply unit, the control unit, and the connection port, the control unit utilized for activating the charging circuit to charge an external device connected to the connection port when the control unit controls the power supply unit to provide power for the connection port, wherein an increase of the average power consumption of the electronic system increases from exceeding the predetermined value to being greater than a charging power consumption.

15. The electronic system of claim 14, wherein the control unit is further utilized for controlling the charging circuit to stop charging the external device and for turning off the charging circuit when a decrease of the average power consumption of the electronic system is larger than the charging power consumption.

16. The electronic system of claim 9, wherein the control unit is an embedded controller (EC), a south bridge, or a central processing unit.
